(19) United States
(12) Patent Application Publication
(10) Pub. No.: US 2016/0088427 A1
(43) Pub. Date: Mar. 24, 2016

(54) LINKING MACHINE COMPONENTS IN BLUETOOTH LOW ENERGY SYSTEM

(71) Applicant: Caterpillar Inc., Peoria, IL (US)

(72) Inventors: Lonny E. Johnson, Peoria, IL (US); Brad K. Borland, Peoria, IL (US); Gopi K. Gaddipati, Peoria, IL (US)

(73) Assignee: Caterpillar Inc., Peoria, IL (US)

(21) Appl. No.: 14/955,031

(22) Filed: Nov. 30, 2015

(51) Int. Cl. H04W 4/00

(52) U.S. Cl. CPC H04W 4/008

(57) ABSTRACT

The present disclosure is related to a method for linking an unlinked Bluetooth low energy (BLE) tagged component of a target machine with an electronic control module (ECM) of the target machine, wherein a plurality of machines are present. The method includes reading the unlinked BLE tagged component by the ECM of the target machine. The method also includes displaying the unlinked BLE tagged component of the available plurality of machines on a user interface of the ECM of the target machine. The method includes moving the target machine away from the other available plurality of machines by a pre-determined distance. Thereafter, the method includes linking the displayed unlinked BLE tagged component with the ECM of the target machine, when the distance between the target machine and other plurality of machines is more than the pre-determined distance.

### TECHNICAL FIELD

The present disclosure relates to a method for linking an unlinked Bluetooth low energy (BLE) tagged machine component, and more particularly to the method for linking the unlinked BLE tagged machine component with the electronic control module (ECM) of the machine.

### BACKGROUND

Servicing station for machines includes multiple service bays having machines lined up in those service bays. Each service bay includes multiple machines for the purpose of servicing, installation or replacement of machine components. Typically a Bluetooth low energy system installed on a target machine is used to communicate with the machine components within a range of the Bluetooth low energy system. Post communication with an electronic control module (ECM) of the target machine, the machine components can be linked to the target machine and may be tracked for future references. While servicing and within the range of the Bluetooth low energy system, the Bluetooth low energy system of the target machine may communicate with the other machine's components. This may create a difficulty in identifying the target machine's components.

U.S. Pat. No. 7,551,086, hereinafter referred as the '086 patent, describes a system and method for tracking aircraft components. The system includes a plurality of aircraft components, a plurality of radio frequency identification (RFID) tags, and a transceiver operatively configured to transmit an activation signal to each of the RFID tags. Each of the RFID tags is associated with a respective one of the aircraft components and comprises identification and maintenance data information specific to the aircraft component to which it is associated. The transceiver is configured to receive information transmitted by each of the RFID tags which are configured to transmit identification and maintenance data information that is representative of a maintenance history for the aircraft component to which the RFID tag is associated. The '086 patent does not show the method for linking of the respective machine components tags wherein multiple machines are present, such as a servicing station.

### SUMMARY OF THE DISCLOSURE

In one aspect of the present disclosure, a method for linking an unlinked Bluetooth low energy (BLE) tagged component of a target machine with an electronic control module (ECM) of the target machine, wherein a plurality of machines are present. The method includes reading the unlinked BLE tagged component by the ECM of the target machine. The method also includes displaying the unlinked BLE tagged component of the available plurality of machines on a user interface of the ECM of the target machine. The method includes moving the machine away from the other available plurality of machines by a pre-determined distance. Thereafter, the method includes linking the displayed unlinked BLE tagged component with the ECM of the target machine, when the distance between the target machine and other plurality of machines is more than the pre-determined distance.

Other features and aspects of this disclosure will be apparent from the following description and the accompanying drawings.

### BRIEF DESCRIPTION OF THE DRAWINGS

FIG. 1 is a perspective view of a servicing station including exemplary machines and a user interface of an ECM of a target machine, according to the concepts of the present disclosure;

FIG. 2 is a perspective view of the target machine along with the user interface of the ECM of the target machine before linking the unlinked Bluetooth low energy (BLE) tagged machine components;

FIG. 3 is a perspective view of the target machine along with the user interface of the ECM of the target machine after linking the unlinked BLE tagged machine components; and

FIG. 4 is a block diagram for a method of linking the unlinked BLE tagged machine components, according to the concepts of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

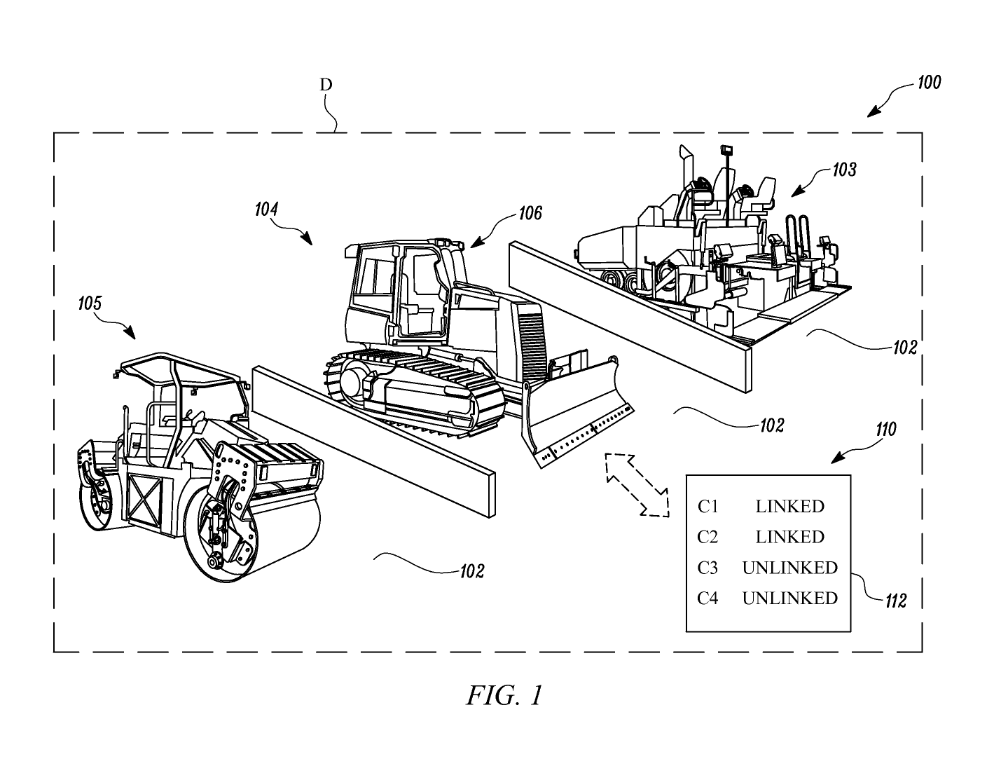

FIG. 1 is a perspective view of a servicing station 100 which includes a paving machine, a tracked machine and a compactor. In an alternative embodiment, the exemplary machines may include any other machines such as loaders, planer, dozers, etc.

The servicing station 100 includes a plurality of service bays 102 located adjacent to each other. In an alternative embodiment, the plurality of service bays 102 may have a perpendicular arrangement or a combination of parallel and perpendicular arrangement. The plurality of service bay 102 includes multiple machines lined up one adjacent to the other. These multiple machines are present in the servicing station 100 for the purpose of servicing, installation or replacement of machine components. As shown in FIG. 1, the plurality of service bays 102 includes a paving machine 103, a tracked machine 104 and a compactor 105. The tracked machine 104 hereby will be mentioned as a target machine 104. The machines shown in FIG. 1 are for exemplary purposes and any other machines may replace these machines.

A Bluetooth low energy system 106 installed on the target machine 104 is used to communicate with a Bluetooth low energy tagged machine components (not shown) present within a range of the Bluetooth low energy system 106. The Bluetooth low energy system 106, hereinafter the phrase ‘Bluetooth low energy’ will be referred to as BLE, installed on the target machine 104 communicates with an electronic control module (ECM) 110 of the target machine 104. During installation of the BLE tagged machine components on the target machine 104, the BLE system 106 will link the BLE tagged machine components to the target machine 104 and will display on an user interface 112 of the ECM 110. The linked BLE tagged machine components will be displayed on the user interface 112 of the ECM 110 as a list and can be tracked accordingly. Thereafter, the linked BLE tagged machine components will not be able to get linked to other BLE system installed on other machines. Further, the unlinked BLE tagged machine components will be displayed on the user interface 112 of the ECM 110 present within the range of BLE system 106. The unlinked BLE tagged components may be of the target machine 104 having the ECM 110 or of any other machines present within the range of the BLE system 106.

The user interface 112 of the ECM 110 will display the linked BLE tagged machine components and the unlinked BLE tagged machine components within the range of BLE system 106. The user interface 112 of the ECM 110, as shown in FIG. 1, displays the linked BLE tagged machine components and detects the unlinked BLE tagged machine components present within the range of the BLE system 106. Post detecting the unlinked BLE tagged machine components, the unlinked BLE tagged machine components are displayed on the user interface 112 of the ECM 110. In an exemplary embodiment, the linked BLE tagged machine components of the target machine 104 are C1 and C2. The unlinked BLE tagged machine components 104 are C3 and C4. The unlinked BLE tagged components may belong to the target machine 104 or may belong to the other machines present within the range of BLE system 106. The range may be defined by a pre-determined distance D which may be a diameter around the target machine 104 having a substantial equal pre-determined distance D from a center-of-gravity of the target machine 104 which includes the BLE system 106.

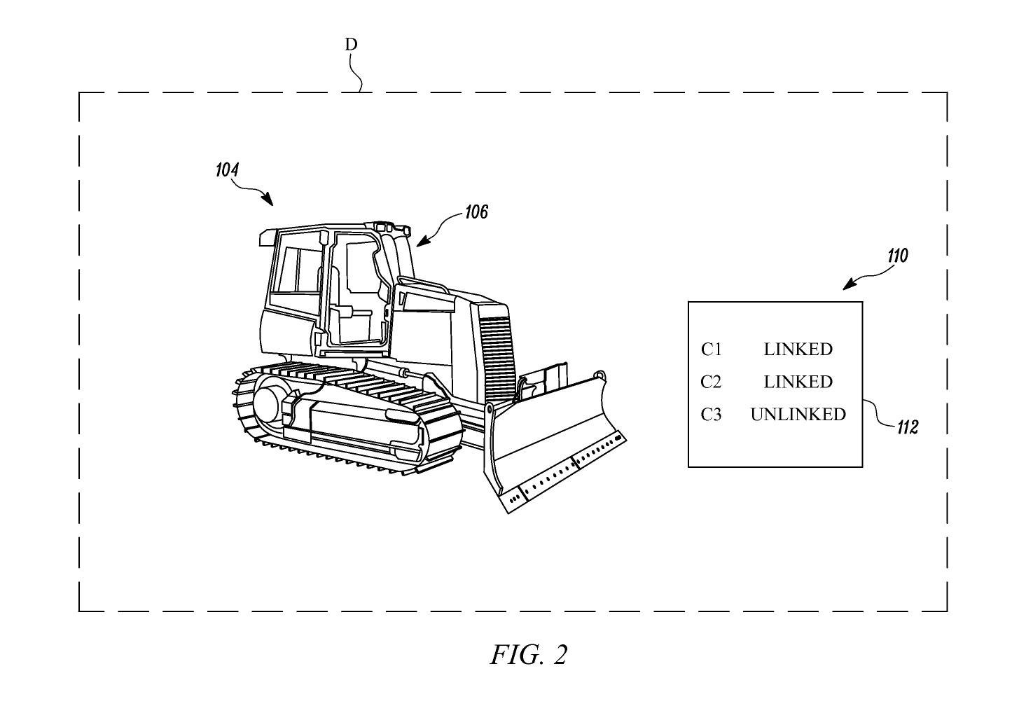

FIG. 2 is a perspective view of the target machine 104 along with the user interface 112 of the ECM 110 of the target machine 104. The target machine 104 is moved away from the other available plurality of machines. Thus, within the pre-determined distance D, the target machine 104 is present. The pre-determined distance D is based on the range of the BLE system 106. The BLE system 106 detects the unlinked BLE tagged machine components. The user interface 112 will then display the machine components including the linked BLE tagged machine components as well as the unlinked BLE tagged machine components of the target machine 104. The unlinked BLE components of the target machine 104 will remain in the communication range of the BLE system 106 of the target machine 104. The unlinked BLE components of the machines other than the target machine 104 will be dropped out of the communication range of the BLE system 106 of the target machine 104. As the target machine 104 is moved away from the other available plurality of machines, the user interface 110 will display the machine components of the target machine 104 including the linked BLE tagged machine components as well as the unlinked BLE tagged machine components. In the illustrated embodiment as shown in FIG. 2, the linked BLE tagged machine components are C1 and C2, whereas C3 is the unlinked BLE tagged machine component. The unlinked BLE tagged machine component C3 belongs to the target machine 104, as the unlinked BLE machine components other than the unlinked BLE tagged machine component C3 are not present within the range of the BLE system 106. In an alternative embodiment, any number of the linked BLE tagged machine components and the unlinked BLE tagged machine components may be shown in the user interface 112 of the ECM 110 of the target machine 104.

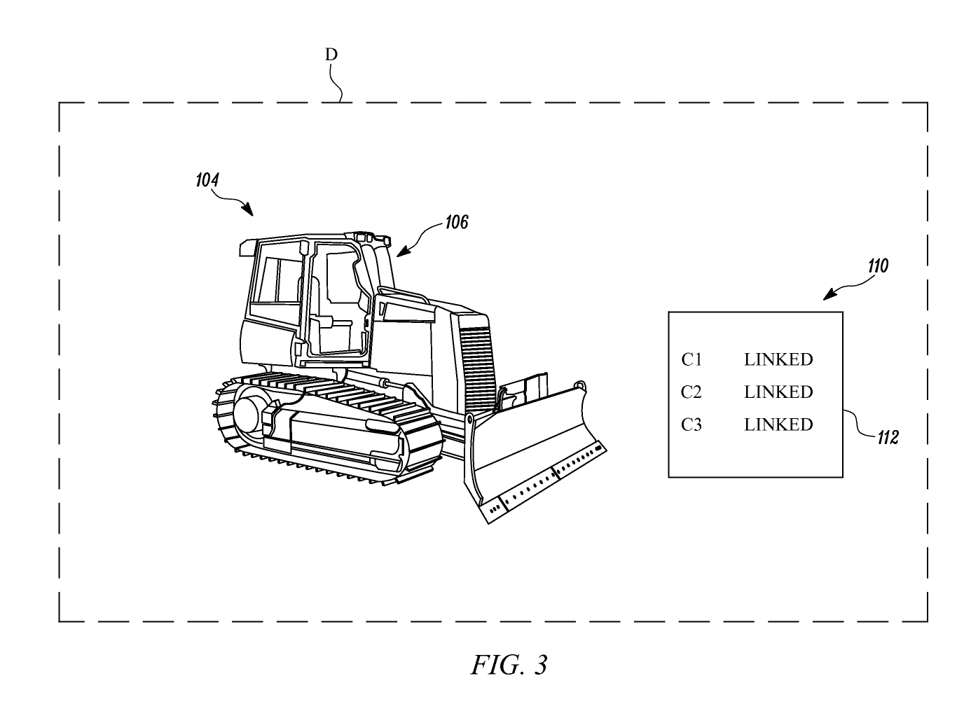

FIG. 3 is a perspective view of the target machine 104 along with the user interface 112 of the ECM 110 of the target machine 104 after linking the unlinked BLE tagged machine components. The displayed unlinked BLE tagged machine components will be linked with the ECM 110 of the target machine 104, in this step. The user interface 112 will then display the linked BLE tagged machine components. The linked BLE tagged machine components will not be displayed in the ECM of other machines, even though they are in the range of BLE systems of other machines. As shown in FIG. 3, C1, C2 and C3 are the linked BLE tagged machine components shown in the user interface 112 of the ECM 110 of the target machine 104. In an alternative embodiment, any number of the linked BLE tagged machine components may be shown in the user interface 112 of the ECM 110 of the target machine 104.

### INDUSTRIAL APPLICABILITY

The present disclosure relates to a method for linking an unlinked BLE tagged component of a target machine with an electronic control module (ECM) of the target machine, wherein a plurality of machines are present. The method includes detecting the unlinked BLE tagged component by the target machine ECM. The method also includes displaying the unlinked BLE tagged component of the available plurality of machines on a user interface of the target machine ECM. The method includes moving the target machine away from the other available plurality of machines by a pre-determined distance. Thereafter, the method includes linking the displayed unlinked BLE tagged component with target machine ECM when the distance between the target machine and other plurality of machines is more than the pre-determined distance. This method links and updates the linked BLE tagged machine components list, thereby notifying the operator of the target machine with regards to the linked BLE tagged machine components present in the target machine and track the performance of the linked BLE tagged machine components. For example, an engine oil filter is installed by replacing the old engine oil filter on the target machine, this method will enable to link the engine oil filter and update the list of linked machine components by adding the engine oil filter to the list. This will be helpful for the operator of the target machine to track the performance of the installed engine oil filter.

This method will notify the mechanic in a servicing station regarding the performance and life associated with the linked BLE tagged machine components of the target machine. Also, this method notifies regarding the modification done with respect to the linked BLE tagged machine components of the target machine by dealers, suppliers and/or customers. The method also enables to prepare reports of the health of the linked BLE tagged machine components of the target machine and notification may be sent to the dealers or suppliers. Further, this method may also keep a track of the linked BLE tagged machine components of the target machine being changed at intervals according to the life of the different machine components. Moreover, this method will also help to keep a track of counterfeit products and genuine products, thereafter notifying the operator regarding the information of the counterfeit or genuine machine components.

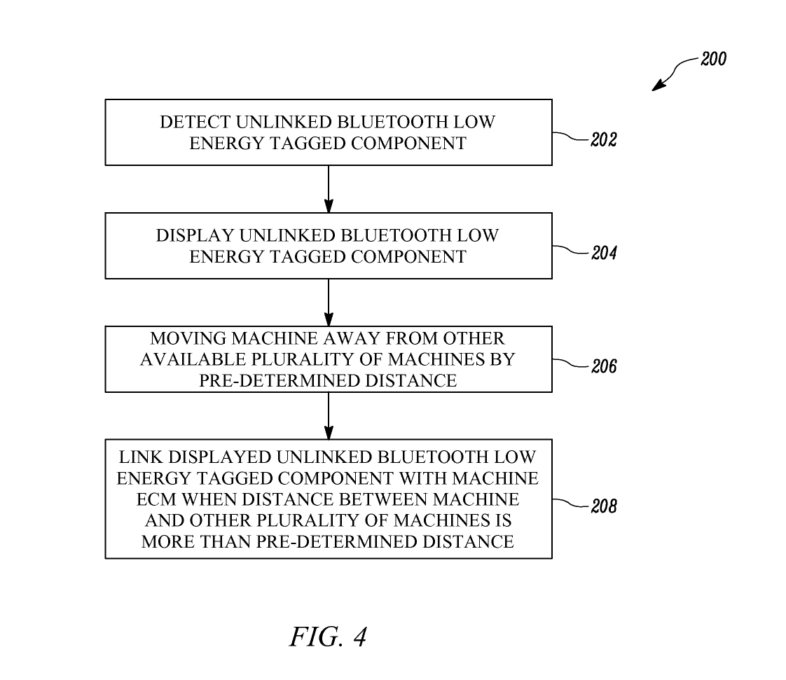

FIG. 4 illustrates a block diagram for a method 200 for linking an unlinked BLE tagged component of the target machine with the electronic control module (ECM) of the target machine, wherein a plurality of machines are present. At step 202, the method includes detecting the unlinked BLE tagged component by the ECM of the target machine. At step 204, the method further includes displaying the unlinked BLE tagged component of the available plurality of machines on a user interface of the ECM of the target machine. At step 206, the method further includes moving the target machine away from the other available plurality of machines by a pre-determined distance D. At step 208, the method further includes linking the displayed unlinked BLE tagged component with ECM of the target machine when the distance between the machine and other plurality of machines is more than the pre-determined distance D. The linked BLE tagged machine components will not be displayed in the ECM of other machines, even though they are in the range of BLE systems of other machines.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for linking an unlinked Bluetooth low energy (BLE) tagged component of a target machine with an electronic control module (ECM) of the machine, wherein a plurality of machines are present, the method comprising steps of:
reading the unlinked BLE tagged component by the ECM of the target machine;
displaying the unlinked BLE tagged component of the available plurality of machines on a user interface of the ECM of the target machine;
moving the machine away from the other available plurality of machines by a pre-determined distance; and
linking the displayed unlinked BLE tagged component with the ECM of the target machine, when the distance between the target machine and other plurality of machines is more than the pre-determined distance.
